(19) United States
(12) Patent Application Publication
(10) Pub. No.: US 2012/0233082 A1
(43) Pub. Date: Sep. 13, 2012

(54) System and Method for Tracking Merchant Performance Using Social Media

(76) Inventors: Joseph Custer, Minneapolis, MN (US); Timothy Crank, Fenton, MO (US)

(21) Appl. No.: 13/207,808

(22) Filed: Aug. 11, 2011

Related U.S. Application Data
(63) Continuation-in-part of application No. 13/042,739, filed on Mar. 8, 2011.

(51) Int. Cl. G06Q 99/00

(52) U.S. Cl. 705/319

(57) ABSTRACT

Disclosed is an electronically implemented method for providing an employee recognition using social media. The method includes providing a computing system having a processor and a data storage component, wherein the data storage component comprises instructions to cause the processor to receive, through a social media platform, an electronic request from a merchant location to provide an electronic recognition to the employee based on the employee's employment-related performance, and provide the recognition to the employee by accessing an electronic forum and posting the recognition in electronic format on such electronic forum. Recognition may be provided by posting the recognition on a social media webpage of the employee.

### CROSS REFERENCE TO RELATED APPLICATIONS

This application is a Continuation-in-Part of U.S. patent application Ser. No. 13/042,739, filed Mar. 8, 2011, entitled “System and Method for Tracking Merchant Performance Using Social Media,” the content of which is hereby incorporated in its entirety by reference.

### FIELD OF THE DISCLOSURE

The present disclosure generally relates to tracking the performance of a merchant. More particularly, the present disclosure relates to systems and methods for using social media to solicit feedback from customers related to one or more topics of interest at the merchant location. The present disclosure further relates to awarding customers of the merchant with incentives, and to recognizing employees of the merchant in relation to their job performance.

### BACKGROUND OF THE DISCLOSURE

Various “social media” platforms, which are typically provided to users thereof in the form of internet websites, are well known in the art. Social media websites provide a forum for users to display personal information about themselves, display personal achievements such as employment-related awards or recognitions, view personal information from other users, and interact with other users in a variety of manners. Popular social media websites include Facebook™, MySpace™, LinkedIn™, Twitter™, ASmallWorld™, Bebo™, Cyworld™, Diaspora™, Hi5™, Hyves™, Ning™, Orkut™, Plaxo™, Tagged™, XING™, and IRC™, etc.

Social media may broadly be understood as the use of web-based and mobile technologies to turn communication into interactive dialogue. Social media platforms use highly accessible and scalable communication techniques. Social media has the capability to reach small or large audiences. Social media can also allow communication virtually instantaneously.

Social media now accounts for 22% of all time spent online in the United States. A total of 234 million people age 13 and older in the U.S. used mobile devices in December 2009. Over 25% of U.S. internet page views occurred at one of the top social networking sites in December 2009, up from 13.8% a year before. The number of social media users age 65 and older grew 100 percent throughout 2010, so that one in four people in that age group are now part of a social networking site.

In the field of marketing, the term “brand loyalty” may be broadly understood as a consumer's commitment to repurchase or otherwise continue using a particular brand of product or service. Brand loyalty is typically demonstrated by repeated buying of a product or service or other positive behaviors such as word of mouth advocacy. Brand loyalty exists when customers have a high relative attitude toward the brand which is then exhibited through repurchase behavior. This type of loyalty can be a great asset to the firm: customers are willing to pay higher prices, they may cost less to serve, and can bring new customers to the firm. Customers' perceived value, brand trust, customer satisfaction, repeat purchase behavior, and commitment are found to be the key influencing factors of brand loyalty.

Lacking in the art are systems and methods that utilize the interactive and networking capabilities to drive brand loyalty. Further lacking in the art are systems and methods that seek to use social media to gain a deeper understanding of consumer behavior, and to leverage that information to better direct product marketing, promotional activities, and employee rewards and recognition programs. Still further lacking in the art are systems and methods that allow an employer to provide recognition, using social media, to its employees for work-related performance.

### BRIEF SUMMARY OF THE DISCLOSURE

In one embodiment, the present disclosure relates to an electronically implemented method for providing an employee recognition using social media. The method includes providing a computing system having a processor and a data storage component, wherein the data storage component comprises instructions to cause the processor to receive, through a social media platform, an electronic request from a merchant location to provide an electronic recognition to the employee based on the employee's employment-related performance, and provide the recognition to the employee by accessing an electronic forum and posting the recognition in electronic format on such electronic forum. Recognition may be provided by posting the recognition on a social media webpage of the employee.

In another embodiment, the present disclosure relates to a computer readable storage medium comprising computer-accessible instructions stored thereon which, when read by a computer, will cause the computer to receive, through a social media platform, an electronic request from a merchant location to provide an electronic recognition to the employee based on the employee's employment-related performance, and provide the recognition to the employee by accessing an electronic forum and posting the recognition in electronic format on such electronic forum.

In still another embodiment, the present disclosure relates to an electronically implemented method for providing an employee recognition using social media. The method includes providing a computing system having a processor and a data storage component, wherein the data storage component comprises instructions to cause the processor to transmit, through a social media platform, an electronic feedback response request to a consumer relating to a topic of interest at a merchant location, and receive, through the social media platform, a consumer feedback response responsive to the response request. The method further includes comparing the feedback response to target response parameters, and providing a recognition to one or more employees at the merchant location if the consumer feedback response is within the target response parameters.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1 depicts the communication interrelationships between the parties-at-interest in accordance with the present disclosure.

FIG. 2 depicts a flow diagram of procedures for tracking customer feedback that may be performed in accordance with the present disclosure.

FIG. 3 depicts a flow diagram of procedures for offering incentives or recognition in accordance with one embodiment with the present disclosure.

FIG. 4 depicts a computer-implemented system suitable for use with embodiments of the present disclosure.

FIG. 5 depicts an example employee social media webpage with a recognition in accordance with one embodiment of the present disclosure.

### DETAILED DESCRIPTION

The present disclosure relates to a novel and advantageous system and method for using social media as marketing platform to drive customer loyalty to a particular merchant or to a particular brand, and/or to reward or provide recognition to the particular merchant or specific employees thereat for doing so, or for any other purpose. In particular, a merchant may establish a profile on a social media platform containing information about the merchant, and allowing users of the social media platform (for example, customers of the merchant who have established profiles on the social media platform) to post feedback or other comments on the merchant's social media profile or website regarding, for example, but not limited to, products or services offered by the merchant, customer service experiences at the merchant location, or the overall customer satisfaction with the merchant location. The merchant may then use this feedback to improve operations at its locations through, for example, but not limited to, employee training, or through targeted responses to specific areas of concern. Using social media as an intermediary for communication also allows the merchant to develop an online community where customers regularly view information about the merchant and provide feedback to the merchant. In this manner, customers may have increased brand loyalty to the merchant through its social media profile created using the social media platform, which may benefit the merchant through repeat sales and potentially increased profits. Customers may be offered incentives through the social media platform to provide feedback responses. Furthermore, employees may be provided incentives or recognition for attaining targets or benchmarks established by the merchant for customer service performance, which in turn may be gauged or analyzed through feedback received on the social media platform. Employees may also be provided recognition for any other employment-related purpose.

The presently described system and method uses a social media platform as an intermediary between customers, a merchant, employees of the merchant, and/or a corporate parent of the merchant or network of merchants. In this manner, the social media platform may serve as a “hub” for communication, wherein the merchant may provide informational and marketing communications to the customer, the customer may provide feedback and responsive information to the merchants, the corporate parent of the merchant may analyze the feedback information and use it to establish performance benchmarks for the merchant or network of merchants in a particular geographical region so as to the improve customer experience, and/or employees of the merchant may be provided incentives or recognition for meeting or exceeding these target benchmarks. Employees of the merchant may also receive recognition for any other aspect of employment-related performance, including but not limited to employment goals, good performance, distinguishing accomplishments, etc. Therefore, the social media paradigm can serve as an improved and more efficient means of communication between the parties at interest in the operation of the merchant location (customers, employees, corporate) to improve, for example, the overall efficiency, profitability, and customer experience at the merchant location. As social media platforms are typically, although not necessarily, owned and operated by entities other than the merchant, or corporate parent of the merchant, the social media platform provides an inexpensive means to interact with a great many customers or potential customers, as compared with traditional marketing and consumer feedback methods.

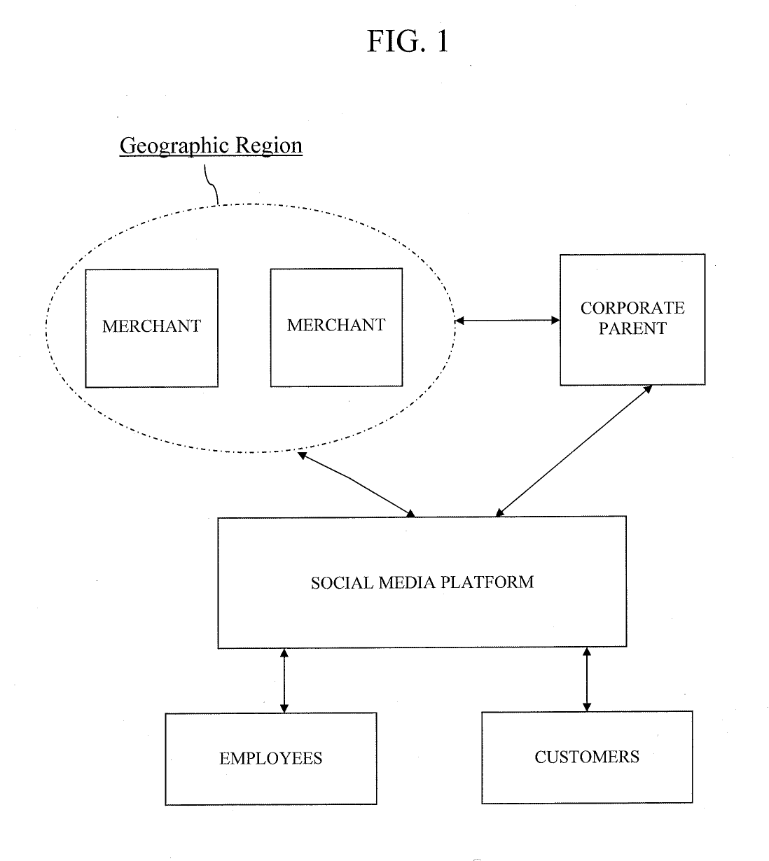

As shown more particularly in FIG. 1, the social media platform can function as an intermediary and communications hub between the interested parties, which as previously mentioned may include the customers, the merchant, employees of the merchant, and the corporate parent of the merchant. As shown by arrows, a merchant may provide product, service, or other marketing information to the customers by posting such information on a profile of the merchant established on the social media platform. The customer, in turn, can provide solicited or unsolicited feedback information to the merchant regarding such products, services, or other customer experiences at the merchant location. Either the corporate parent of the merchant or other agents of the merchant (i.e., store managers) may access such feedback information to, for example, but not limited to, establish benchmarks for performance, or to directly respond to specific issues in the merchant location in a timely manner. In further embodiments, the corporate entity may use this feedback information to incentivize or recognize employees to perform at the target level by offering incentives or recognition for meeting benchmarks, which may be determined by, for example, analyzing further feedback information from a plurality of customers over time. Employee recognition can, in some embodiments, be provided through use of the social media platform. Targets and benchmarks may be updated over time in a dynamic fashion to respond to changing trends, improvements, or other reasons gleaned from feedback analysis.

Furthermore, the social media platform can be used to provide recognition to employees for any employment-related purpose. For example, where an employee of the merchant performs particularly well over a period of time, or makes a distinguishing accomplishment, or achieves any set goal, among other things, the social media platform, as will be described in greater detail below, may be used to provide the employee with a recognition for such accomplishment or such goal.

Embodiments of the presently described system and method may allow a merchant to leverage information received from customers through the social media platform to improve its products and services offered, and to improve its customers' experience, etc. Information received through the social media platform from customers may also be used by the merchant to drive future promotional activities, for example, promotional activities that may be directed towards particular customer interests. In some embodiments, such information about customers' interests can be learned from the customers' social media profile, which is accessible to the merchant through the social media platform after a relationship with the customer has been established. However, such information may be gathered in other manners such as, but not limited to, traditional questionnaires or other feedback mechanisms. In this manner, the operations at the merchant location may be dynamically adjusted and improved based on feedback received through the social media platform. This dynamic or substantially real-time information may allow the merchant to make quicker improvements to their products, services, and operations, and then wait and see how customers respond to such changes in real time, through, for example, comments left on the merchant's social media profile, or through other feedback mechanisms available on the social media website. Therefore, the social media profile of the merchant can be leveraged, with information received from the customer, to improve the overall experience at a merchant location, in quick and/or dynamic manner.

In one embodiment, a merchant, a group of merchants, or other retail establishments, may establish a “profile” on a social media website. A profile on a social media website can serve as a means for interacting with customers who are also members of the social media website, and who may themselves have profiles on that social media website. A merchant may establish a profile on a social media website in several ways: In one embodiment, the merchant may access the social media website and manually set up a profile, which may include information about the merchant, including store name, address, telephone number, or other information that a customer may seek. In another embodiment the merchant may use a software platform configured to access a system of social media website, wherein the software platform provides a template for the merchant to establish a profile, and then the software platform directly establishes a profile through operative communication with the social media website, based on the template. In this manner, the merchant profile on the social media website may provide an online social community based around the merchant (or the network of merchants) who maintain the profile. Customers, through their own profiles on the social media website, may thus interact with the merchant, and the merchant may provide the customer with valuable information, marketing offers, promotions, and/or the merchant may solicit feedback from the customer on any number of topics, including products available at merchant, services provided by the merchant, or customer service experience while at the merchant location.

In some embodiments, a social media profile may be created for a group of merchants within a particular geographic region, or for the corporate parent of a plurality of merchants, among other hierarchical levels. Any given merchant location may be associated with social media profiles on one or more levels. For example, it is anticipated that for some merchants, the merchant may have its own social media profile unique to that specific merchant location, it may also be associated with the social media profile of the geographical region of merchant wherein it is located, and it may also be associated with the social media profile of its corporate parent. Other combinations are of course possible.

A social media profile established by the merchant may include an informative component and an interactive component, among other things. The informative component may include information regarding the merchant, which may include products available, services available, contact information, promotional offers, or any other information that a merchant may wish to provide to a customer. The interactive component may include one or more solicitations for information from the customer, which may take the form of various feedback requests, including, for example, but not limited to, open comments, directed comments, multiple-choice questionnaires, or any other kind of information request form. The informative component and the interactive component may be established on the merchant's social media website manually, by an agent of the merchant (e.g., store manager) accessing the merchant's social media profile and establishing these components. In another embodiment, the previously described software platform may be further configured to allow the merchant to use a template to establish the informative component and the interactive component, whereafter, the software platform accesses the system of the social media website to establish the informative component and the interactive component of the merchant profile based on the template.

A social media relationship may, in some embodiments, be established in a two-step process. First, the merchant establishes a profile, or website, on the social media platform, providing information about the merchant, and areas where customers may provide feedback to the merchant, as discussed above. Second, a user of the social media platform, which may be, but is not limited to, a customer of the merchant, or a potential customer of the merchant, initiates a relationship with the merchant through electronic communication means on the social media platform. This electronic communication means may take a variety of forms, depending on the particular social media platform used. For example, on the popular social media website Facebook™, a social relationship may be established by “friending,” “liking,” and/or becoming a “fan” of the profile of the merchant. This establishment is an electronic indication that the customer wishes to engage with the merchant profile on the social media platform. Other forms of relationship establishment on other social media websites are of course considered within the scope of the present disclosure. Once a social relationship has been established between the merchant and the customer, the merchant may have access to certain personal and demographic information of the customer that may help the merchant to better market to the customer, and to potentially provide better products and services to the customer, as will be discussed in greater detail below.

Once a social media relationship is established with a customer, the merchant may be able to access more efficient forms of communication with the customer. For example, in traditional marketing, a merchant may communicate with the customer through unsolicited telephone calls, direct mail, e-mail, or other forms of marketing communication. In contrast, on a social media platform, the merchant has access to a pool of customers who, by virtue of having established a relationship with the merchant, are already interested in the products or services offered by the merchant, and therefore will likely be more receptive to communication from the merchant. Moreover, communication means on the social media platform are generally more direct and are more noticeable to the customer than “junk mail” or “cold calls”, including, for example, instant messaging, leaving comments on a social media profile, or direct e-mailing to a customer email account associated with the social media platform. In this manner, the social media platform allows the merchant more direct and effective communication with customers who will generally be more receptive to the merchant's marketing efforts.

In one embodiment, the social media profile or website of the merchant location may be configured, at least a portion thereof, to solicit feedback from customers. The feedback solicitation components, which may also be known as a customer interactive component, may be configured to solicit information from customers regarding any topic of interest at the merchant location. Topics of interest may include, for example, but not limited to, products offered, services offered, customer service, overall customer experience, or any other topic of interest to the merchant. The customer interactive component may include an open comments section, wherein customers may access the profile of the merchant at the social media website and provide comments on any topic, for example, a recent experience at the merchant location. In other examples, the interactive components may be more “directed”, in that the customer provides feedback in response to a particular question or questions, for example, a recent change to the merchant location, a recent promotional offering, a new product or service offering, or the customer's experience at the merchant. The customer interactive component may be configured on the social media profile of the merchant in any known manner, for example, multiple-choice questions, text box, hyperlinks, or any other known means. Customer feedback may thereafter be monitored by the merchant, and, in some embodiments, stored in a database for later analysis and/or benchmarking procedures.

In a further embodiment, the social media profile or website of the merchant may be configured so as to allow the merchant to respond to customer feedback. For example, if a customer posts a response about a negative experience at the merchant location, the merchant may access its social media profile and send a message through the social media platform to the customer, or the customer's social media profile, responding to the feedback.

In general, a customer may provide solicited and/or unsolicited feedback to the merchant by accessing the social media website or social media profile of the merchant. In one embodiment, the customer may also be a member of, or have a profile on, the social media website in order to access the merchant's profile. In another embodiment, anyone, regardless of affiliation with the social media website, may access and provide feedback to the merchant through the merchant's social media profile. It will be appreciated that any of the established communication means of known social media websites may be used by customers to provide feedback to the merchant. For example, it is common on many social media websites to have an “instant message” function, wherein a user can type a short message and send it directly to any other user's profile or e-mail account. Other known means are considered to be within the scope of the present disclosure.

Questions posted by the merchant through its social media profile may be provided in any number and any frequency. In one embodiment, one question related to a product, service, or customer experience may be posted by the merchant on a weekly interval, or other regular time interval. In this manner, customers who have a social relationship with the merchant through the social media platform know to expect a new question at a set time that they can access and respond to. In another embodiment, the merchant profile may have an area that is continuously open to customer comments on any topic, and at any time. For example, on the social media website Facebook™, the “wall” is an area on a profile where other users can always post comments which are readable by, for example, a merchant and/or other users at any time.

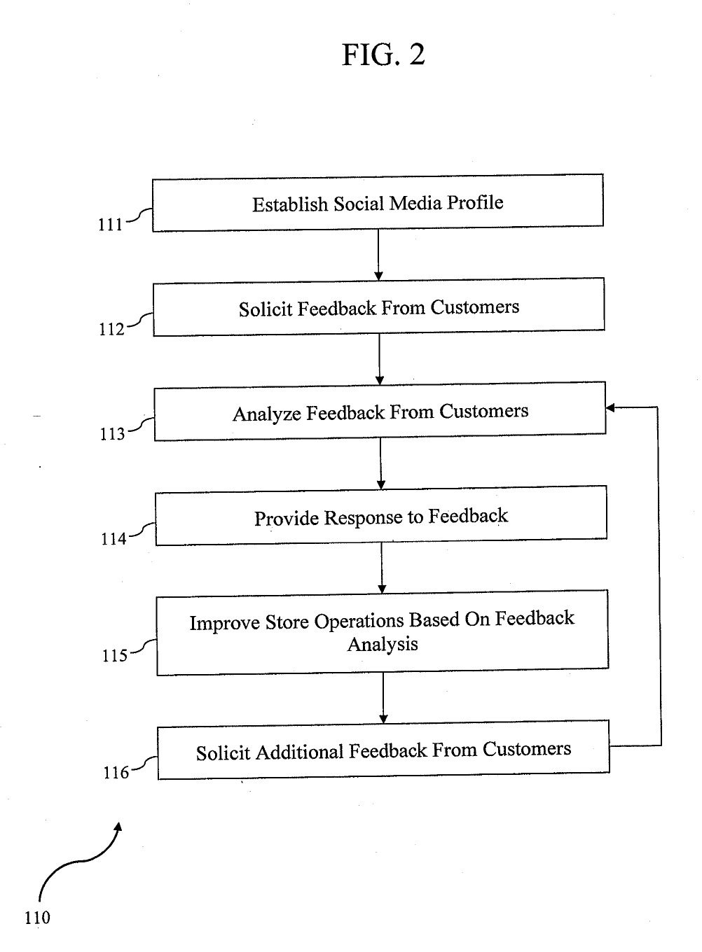

As depicted in FIG. 2, procedures for tracking customer feedback information are shown in a flowchart 110. At procedure 111, the merchant, or a corporate parent of the merchant, establishes a social media profile on a social media platform. As previously discussed, this procedure may be performed manually, by agents of the merchant, or it may be performed automatically, using a template of a software program configured to operatively communicate with the system of the social media platform. At procedure 112, the merchant solicits feedback from customers regarding a particular topic of interest, which may be a product or service, or improvement to customer service, among other things. At procedure 113, the feedback information can be analyzed either manually by an agent of the merchant, or using the software program, which has been configured to retrieve and analyze information from the social media platform. At procedure 114, the merchant may provide a response to the feedback, in the form of an instant message, e-mail, or other communication means, which may or may not be conducted through the social media platform. At procedure 115, the merchant may use the analyzed feedback information to respond to any issues evidenced by the feedback, which may include, but is not limited to, improving store operations, redesigning marketing efforts, retraining employees, or changing products or services offered, based on the comments received from customers. For example, if it is discovered that a particular department of the merchant is not operating at customers' expectations, employees within that department may be retrained, or procedures within that department may be modified, to seek increased consumer satisfaction therewith. At procedure 116, the merchant may solicit additional feedback regarding the modifications to the topics of interest identified in the previous feedback solicitation, in order to determine if the modifications deployed have made an improvement. As shown in the flowchart, the procedure may then continue again at procedure 113, in an iterative and dynamic process, which continuously seeks to improve merchant performance from a customer standpoint. Of course, it will be appreciated that while FIG. 2 depicts certain procedures as enumerated above, more or fewer procedures may be employed, including eliminating iterative procedures, consistent with the scope of the present disclosure. Moreover, procedures shown in FIG. 2 need not necessarily be executed in the order presented.

In further embodiments, tracking improvements to topics of interest need not necessarily be related to monitoring further feedback from customers. In some embodiments, the merchant may employ non-social media platform-based monitoring systems to track topics of interest to the merchant. For example, with regard to the checkout counter wait time at a merchant, rather than soliciting additional feedback (or receiving unsolicited feedback) from customers regarding the wait time, the merchant may employ in-store monitoring systems to track the average customer wait time at the checkout counter. Further, the merchant may employ “secret shoppers” to assess topics of interest regarding a particular employee's or a particular department's performance, among other things. Other means of non-social media platform-based monitoring are possible. Combinations of two or more types of tracking are also possible.

In one embodiment of the present disclosure, incentives may be provided to customers who maintain a social relationship with the merchant through the social media platform, by, for example, providing a feedback response to a particular question posed by the merchant through the social media platform. For example, a merchant may offer an incentive to a customer by posting information on its social media profile that a particular incentive is available for responding to a particular question in the manner indicated. Where a customer provides a response through the social media platform in the manner indicated, the merchant may then provide the customer with one or more incentives for providing the response. In further embodiments, the merchant may offer incentive for merely beginning the electronic social connection with the merchant, for example, by “friending” the merchant. In this manner, customers are incentivized to initially join the social community surrounding the merchant, thereby possible making the community stronger and more attractive for others to join.

The incentive may take the form of a free product or service, a discounted product or service, reward points in connection with a customer loyalty program, or any other customer incentive. In this manner, the merchant may be able to more actively solicit feedback information from customers, as customers may be more willing to provide such feedback where an incentive is involved. In one embodiment, incentives for feedback responses may be managed by an agent of the merchant (e.g., a store manager) manually by accessing the profile of the merchant on the social media platform and collecting information regarding customers who have responded to a particular question. In other embodiments, the merchant may employ a software program (as discussed above) which may also be configured in operative electronic connection with the social media website in order to retrieve such customer response information, and aggregate that information into a database accessible by the merchant. Such incentives may be provided by any known means for example, through the mail, e-mail, pick-up at a merchant location, or electronically through a customer loyalty program. In further embodiments, incentives may be provided through the social media platform itself. For example, numerous social media platforms now offer forms of monetary currency that users of the platform may use to access certain products or features of the platform. For example, Facebook™ now uses a form of “currency” to allow its users to play games and access other features through its website, and its affiliates' websites.

In further embodiments, the incentive may involve a product or service offered from one or more corporate sponsors that may or may not sell products or offer services through the merchant location. In these embodiments, where a customer responds to a feedback solicitation, the customer may be provided with an internet webpage link, other electronic linking form, or other directions to access electronic content, or other non-electronic content, provided by the corporate sponsor. The electronic content may be provided at a corporate webpage of the corporate sponsor, and include information regarding a discount on a product or service provided by the corporate sponsor, a free product or service, or other incentive award offered directly by the corporate sponsor, in connection with the feedback solicitation of the merchant location. In this manner, the merchant location may be able to offer a wider variety of incentives to customer's through affiliation with one or more corporate sponsors, and thus may be able to share the cost/benefits of the incentive programs with such corporate sponsors. In a particular embodiment, the incentive may be a discount on a particular product or service offered through the corporate sponsor's webpage, and the social media profile of the merchant location may provide a customer who gives a feedback response a direct link to the corporate sponsor's webpage such that the customer may immediately link to that sponsor's website and make a purchase with, or otherwise redeem, the incentive.

In some embodiments, an established loyalty program of the merchant may be linked with the social media profile of a merchant on the social media platform. For example, users who are members of a merchant loyalty program may be offered promotions or additional promotions through the social media platform as an incentive for the customer to give repeat business to the merchant. As such promotions will be visible to all users of the social media platform, even ones who are not members of the loyalty program, such advertisement may incentivize non-member customers to join the loyalty program in order to access the promotions. In this manner, not only can the social media platform drive repeat business to the merchant through direct offerings and direct feedback, it can also be used to develop further brand loyalty through incentives to join a customer loyalty program previously established by the merchant. Incentives offered to customers through the social media platform can also be linked to traditional loyalty programs, for example, feedback responses can be incentivized with additional points rewarded to the customer through the merchant's traditional loyalty program.

A further aspect of the present disclosure is a system and method for tracking customer responses received through the social media platform. In this regard, a merchant, or a network of merchants, may establish one or more benchmarks for store performance. The one or more benchmarks may be centered around an individual merchant location, or it may be based on a geographical area comprising two or more merchant locations. A benchmark serves to gauge the performance of the merchant in any number of categories, including, but not limited to, product selection, customer service, overall customer experience, or any other topic of interest that the merchant may seek to establish standards for performance. Benchmarks may also be employed in categories that may not necessarily relate directly to the performance of a merchant. For example, such benchmarks may include, but are not limited to, the number of people that visit the merchant over a given period of time, whether an employee greets a customer with a smile or a “hello”, or the number of customers who respond to a feedback solicitation on the merchant's social media profile.

The one or more benchmarks may be established by an agent of the merchant, or an agent of the network of merchants in a geographical area (e.g., the corporate parent, or a regional office of the corporate parent, of the merchant). The benchmarks may be established based on a desired level of merchant performance in any of the above-described areas. In one example, a benchmark may include a maximum desired wait time at a checkout line at a merchant location. Where the merchant location consistently delivers customer checkout services at a time that is the same or shorter than the benchmark, the merchant can be considered to have met the benchmark. However, if the checkout services consistently take longer than the benchmark, then the benchmark has not been met. In another example, a benchmark may include a minimum number of people responding to a particular feedback solicitation on the merchant's social media profile. Where the merchant location receives at least the minimum number of responses within a specified time period, the merchant can be considered to have met the benchmark. However, if fewer than the minimum number respond, then the benchmark has not been met. As will be discussed in greater detail below, merchant performance may be judged against the benchmark, or benchmarks, by information received from solicited or unsolicited comments transmitted from customers to be social media profile of the merchant.

In a further embodiment, the benchmarking process may be a dynamic process. That is, rather than establishing a single and permanent benchmark for a particular topic of interest, the benchmark may be reassessed or reevaluated based on customer feedback. For example, if it is found that an initial benchmark is not meeting the expectations of customers, then the benchmark may be adjusted to better meet the expectations of customers based on the feedback received, wherein the feedback may have been received through the social media profile of the merchant. Alternatively, the benchmark may be adjusted over time as the merchant improves performance, in order to, for example, continuously raise the bar for performance as the merchant becomes more efficient in its operations.

Upon receiving feedback information from a customer, in one embodiment, the presently described system and method may include a procedure for dynamic or intelligent statistical analysis of the feedback data. For example, the feedback information may include feedback responses that are inherently susceptible to statistical analysis. These include, for example, multiple-choice questions, scale ratings, short answer with text mining (for example, mining for key terms), numerical responses (e.g., amounts, times, percentages, etc.) and other data that can be easily analyzed and compared. In some embodiments, the statistical analysis may be based upon a single data source, for example, customer responses to a single scale-rated question. In other embodiments, the statistical analysis may be based on two or more data sources, for example, a combination of a scale-rated question, a multiple choice question, and a text-mined short answer question. Other combinations of two or more data sources are of course possible. One purpose of such statistical analysis is to achieve an understanding of the customer experience in a merchant location across a sample set of a plurality of customers, rather than looking at individual customer responses, which may be skewed with a small sample set. Of course, such statistical analysis is not limited to the above enumerated options, but may be applied generally to any type of feedback response. Statistical analysis may be performed manually by an agent of the merchant, for example, by manually retrieving responses from the merchant's social media profile and aggregating the responses into a database, wherein the responses may be manually parsed to extract the relevant data, which may be then summarized into tables, graphs, charts, or numerically manipulated by any known means of statistical analysis. In other embodiments, a software program (as described above), with operative communication to the social media website of the merchant may be further configured to retrieve and aggregate the customer responses into a database. Thereafter, the software may electronically perform one or more types of statistical analysis, and output the analysis to an agent of the merchant, or corporate parent of the merchant, in any form desired. Such statistical data may be used by the merchant to, for example, establish benchmarks for performance, improved employee training, update standard procedures, and identify areas of concern for targeted improvement, among other things.

In further embodiments, a merchant may also perform a qualitative analysis on the feedback responses received from customers through the social media platform. For example, where a customer leaves a comment comprising sentences on the social media profile of a merchant, such response may not generally be well-suited to statistical numerical analysis without lengthy manipulation. Thus, it may be beneficial for an agent of the merchant to manually read written responses or comments and annotate the responses with key topics for later review. For example, a merchant may receive a response from a customer about a bad experience that the customer had in a particular department of the merchant. An agent of the merchant may annotate this response, and send the response for further review to the particular department at issue, or another suitable department such as a quality assurance department, in order to address the particular concerns of the customer. This individual and targeted response analysis may be provided in alternative or in addition to the statistical numerical analysis discussed above in order to best improve merchant performance across all customer experience metrics.

In one embodiment, the presently described system and method may be configured so as to provide employees of the merchant with incentives or recognition for meeting or exceeding targets or benchmarks. Employee recognition may also be provided for any other employment-related purpose. As previously discussed, targets or benchmarks may be established by the corporate parent or agents of the merchant (e.g., store manager) based on a desired or optimal level of employee performance. Targets or benchmarks may also be established by analysis of feedback from customers, and targeted at particular topics of interest. Once the targets or benchmarks are established, employees at the merchant location may be trained so as to adequately meet the benchmarks from a customer service standpoint, and thereafter, future customer feedback and responses received through the social media platform, and/or non-social media-based monitoring means, may be monitored and qualitatively or quantitatively analyzed over time to determine whether or not the targets or benchmarks are being met.

In one embodiment, where targets or benchmarks are being met, individual employees, responsible employees, or all employees of a particular merchant location may be rewarded with an incentive for achieving the desired goals. Furthermore, because targets and benchmarks may be established on a geographical-region basis, all employees within such geographical region may be rewarded with incentives if such wide-area benchmarks are met. Employee incentives may include anything of value to an employee, for example, but not limited to, monetary rewards, free products or services, discounts on products or services, promotions, increased perquisites, or any other form of incentive, or combination of incentives.

In another embodiment; where targets or benchmarks are being met, individual employees, responsible employees, or all employees of a particular merchant location may be recognized with one or more forms of recognition for achieving the desired goals. Furthermore, because targets and benchmarks may be established on a geographical-region basis, all employees within such geographical region may be recognized with one or more forms of recognition if such wide-area benchmarks are met. In other embodiments, employees may be recognized for any employment-related purpose. For example, an employee may have met a particular goal that may be unrelated to the targets or benchmarks previously discussed. In another example, the employee may have performed their duties in a distinguished manner, or reached a particular milestone related to their employment. In such embodiments, the presently described systems and method may be used to provide a recognition to such employee for the employment-related purpose.

Employee recognition may include anything, whether tangible or intangible, that serves to show that an employee or a group of employees is being recognized for a particular accomplishment. Examples of employee recognition may include, but are not limited to, verbal recognition, where the employee or group of employees is verbally recognized for an accomplishment by a supervisor, manager, other employee, or other person; written recognition, where the employee or group of employees is provided a recognition in written form, such as a certificate, award, letter of recommendation, letter of thanks, memorandum, poster, plaque, scroll, insignia, or other written mode of recognition; or electronic recognition, where the employee or group of employees is provided a recognition in electronic form, such as an e-mail, a recognition on a website such as the merchant's website, a recognition on a social media webpage of the employee, or an electronic version of any of the above-mentioned written recognition forms.

With further attention to embodiments where recognition may be provided in electronic form through a social media webpage of the employee, such recognition may, in some embodiments, be provided using the presently described social media platform. It will be appreciated that various social media websites, such as LinkedIn®, Facebook®, and others, allow users thereof to post for public viewing any honors, awards, achievements, recognitions, etc. that they have achieved. In particular, at social media websites that focus on employment, networking, and business, and other like concerns such as LinkedIn®, recognitions received from an employer may be particularly relevant.

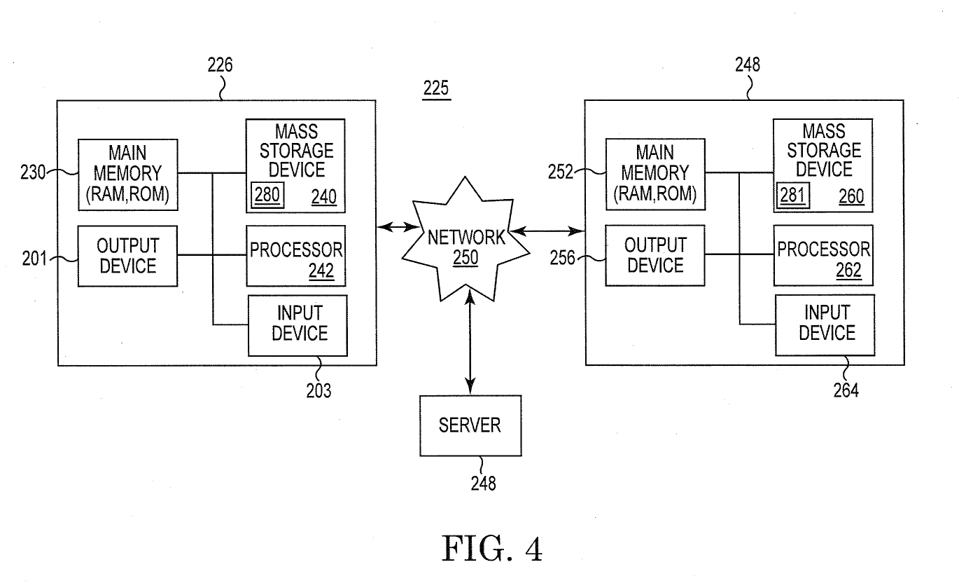

In one embodiment, the presently described social media platform may be further configured to interface with a social media webpage of one or more employees. As described above, such interface may be provided by an electronic connection means, for example by using an electronic network such as the Internet to communicate electronic data and by using software adapters to coordinate and correlate such data transfer. As shown in FIG. 4, discussed in greater detail below, network 250 may be provided as the electronic connection means. Alternatively, such interface may be provided by the social media platform being integrated with the systems of the social media website. Where an employee has earned a recognition as described above, the social media platform may generate an electronic recognition, access the social media webpage of such employee, and post such recognition thereon in electronic format whereafter it may be visible to any viewer's of the employee's webpage according to the standard rules and procedures of the respective social media website.

The social media platform may gain access to the employee's webpage according to the rules and procedures of the respective social media website. For example, where the social media website requires password access to an individual webpage, the employee may need to provide such password to the social media platform in order for it to access the employee's webpage and post the recognition. In another example, the social media website may require employer (merchant) verification, wherein only verified employers (merchants) that have been pre-screened by the social media website are allowed to access the webpages of its employees to post the recognition. In yet a further example, the social media website may require a pre-existing electronic relationship between the employer and the merchant on the social media website (for example, Facebook® establishes such relationships by “Friend Requests”) before the social media platform has access to the employee's webpage to post the recognition. In still a further embodiment, the social media website may have no restrictions as to the posting on individual webpages, and in such embodiments the social media platform may access the employee's webpage without a password, verification, or prior electronic relationship, etc.

Once the social media platform gains access to an employee's webpage in any of the manners discussed above, the social media platform may post the recognition in any manner desired. For example, on some social media websites, there are dedicated portions of an individual's webpage for posting such recognitions. In one particular example, with regard to the website LinkedIn®, there is typically a dedicated area where a user may post honors, awards, and achievements. In this example, the social media platform may post the recognition at such area. In other embodiments, the social media website may not have such a dedicated area, and thus the social media platform may post the recognitions on the employees webpage generally at any location.

Employee recognitions may be posted in any form on the employee's social media webpage. In some examples, the recognition may take the form of a textual recitation of the employee's achievement. For example, such a recitation may include “[Employee Name] has received the award for outstanding employee, [Merchant Location], for [Time Period].” The merchant may generally have control over the verbiage of the recognition, and may supply such verbiage to the social media platform for posting on the employee's social media webpage. In this way, the merchant can make sure any such verbiage is in line with any credential or other policies the merchant has, such as but not limited to confidentiality policies. In other examples, the recognition may take the form of a visual or graphic representation of the employee's achievement. For example, an image of a trophy or certificate, with the merchant logo provided thereon, could be used. Of course, combinations of textual and visual or graphical electronic recognitions are possible.

In further embodiments, in the alternative or in addition to posting the award at a social media webpage of the employee, the merchant may use the social media platform to post the recognition in electronic form at a social media webpage, or other website, of the merchant. For example, as previously discussed, merchants in accordance with the present disclosure may maintain webpages on one or more social media websites. One or more areas on such social media webpages could be dedicated to posting employee recognitions for viewing by the public. Further, one or more areas of the merchant's Internet website may be dedicated to posting employee recognitions for viewing by the public. More than one instance of the recognition may be posted. For example, the recognition may be posted on one or more of the employee's social media webpages, one or more of the merchant's social media webpages, and/or one or more of the merchant's business websites. One or more forms of verbal and written recognition may also be provided in connection therewith.

It will be appreciated that recognition may be provided in additional to other incentives or awards. For example, where an employee achieves a particular target, the employee may be awarded with both an incentive of some value, in addition to a recognition, for example that may be posted on the employee's social media webpage. Furthermore, it will be appreciated that, in some embodiments, the employee may retain ultimate control over what is posted on his/her social media webpage, wherein, for example, the employee may prevent the social media platform from posting recognitions thereon, or may delete recognitions that have previously been posted.

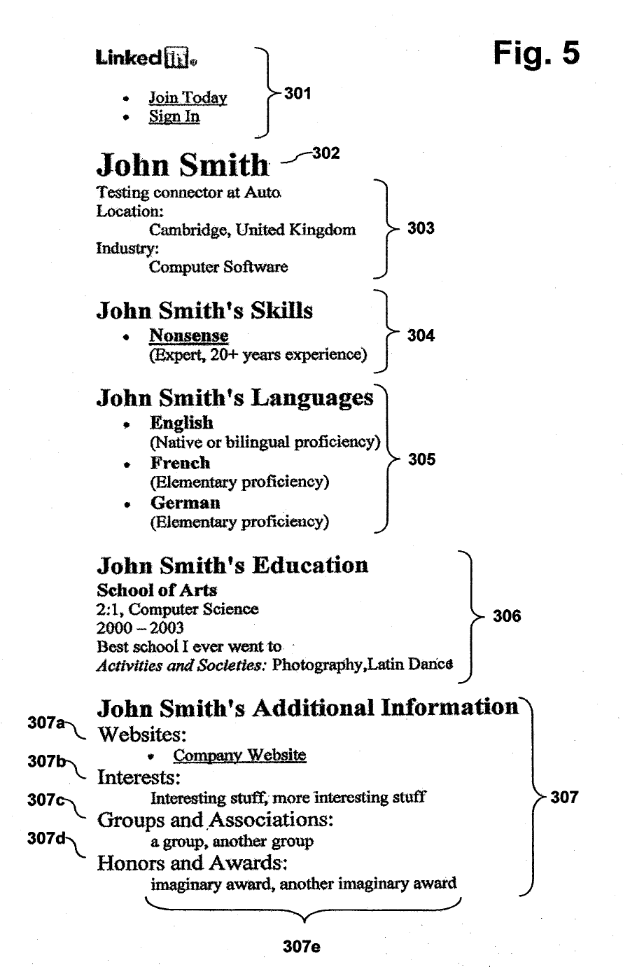

FIG. 5 shows an example employee social media webpage in accordance with the present disclosure. The employee webpage, hosted by the social media website LinkedIn® (301), as shown generally includes professional information regarding the employee “John Smith” (302). Information on such social media webpages may include, but is not limited to, occupational information (303), skills information (304), languages information (305), education information (306), and additional information (307), among other things. As shown in the additional information (307) area, information is provided regarding websites (307a), interests (307b), groups and associations (307c), and honors and awards (307d). As discussed above, in some embodiments, the employee recognition may be provided by the social media platform under the honors and awards category (307d). However, it may be provided in other areas alternatively or additionally. As shown thereat, John Smith (302) has received a recognition for “imaginary award” and “another imaginary award” (307e), either or both of which may have been posted there by the social media platform in response to John Smith (302) achieving a particular target or goal while employed at the merchant.

Thus, in one embodiment, an employee recognition program using the presently described social media platform may be provided as follows. A participating merchant location may set targets or goals for one or more employees to achieve. The merchant may ascertain the achievement of such targets or goals using the social media platform, for example, by soliciting and receiving feedback from one or more customers regarding one or more topics of interest. The results of such feedback may be analyzed, and compared to the targets or goals. If the targets or goals are met, one or more employees responsible therefore, or employees at such merchant location generally, may be provided a recognition. In other embodiments, however, an employee or group of employees may be provided with a recognition for any desirable conduct or employment-related conduct, such as but certainly not limited to, meeting a particular goal or performance level, performing the employee's duties in a distinguished manner, completing a particular task, going beyond the employee's basic duties, etc. Such recognition may be provided by, using the social media platform, posting such recognition on a social media webpage of the employee. As such, the social media platform may be configured to electronically interface with the social media webpage of the employee, which may include password access, verification, and/or a preexisting electronic relationship.

Returning now to discussion of the merchant's established targets or benchmarks, in some instances, it may be observed that targets or benchmarks are not being met. In this case, information received through the presently described system and method, for example feedback through the social media platform, may be used to develop improved employee training programs. For example, analysis of customer commentary received through the social media platform and/or non-social media-based monitoring means may reveal that a particular area at a merchant location is not meeting expectations. Using this information, employees responsible for the particular area may be required to take additional training programs that are directed to address the particular topic of interest identified through the feedback responses. In this manner, employees may be trained more efficiently on areas that are of particular concern to customers. As a result, significant time may be saved as compared to traditional training programs that cover a wide variety of topics that may be already well met by the employees' performance. In one embodiment, such training programs may be developed on a merchant network-wide basis, for example, a geographic area, by the corporate parent of a merchant. Alternatively, such training programs may be developed in a more targeted manner, for example, by the store manager of a particular merchant location to address an area of interest that is of particular concern to that merchant location.

In further embodiments of the present disclosure, the corporate parent of a merchant may establish performance competitions for participation by merchant locations within a particular geographic area. The merchant location that performs the best within the specified criteria and within a particular period of time may receive an extra incentive for its employees, or particular employees, for “winning” the regional competition. The competition may be based around any target or benchmark or topic of interest. For example, a corporate parent may desire to reduce the wait times at the checkout counter at stores within a particular geographic region. Therefore, the corporate parent may establish a regional competition, wherein the merchant location that reduces its checkout counter wait time by the most amount of time within a given timeframe wins the competition. Winning results, of course, may be determined by analysis of feedback received through the profile of the merchant on the social media platform and/or non-social media-based monitoring means. For example, a weekly question may be posted wherein customers may rate the wait time at a checkout counter by numerically entering the average time that they had to wait during that particular week. Over several weeks, the data may be statistically analyzed, and the merchant location within the geographical region that has the greatest improvement (or employees thereof) may be rewarded with the stated incentive. Of course, competitions are not limited to a regional basis, but may be employed at any geographical area of interest, for example, city, county, state, nation, etc.

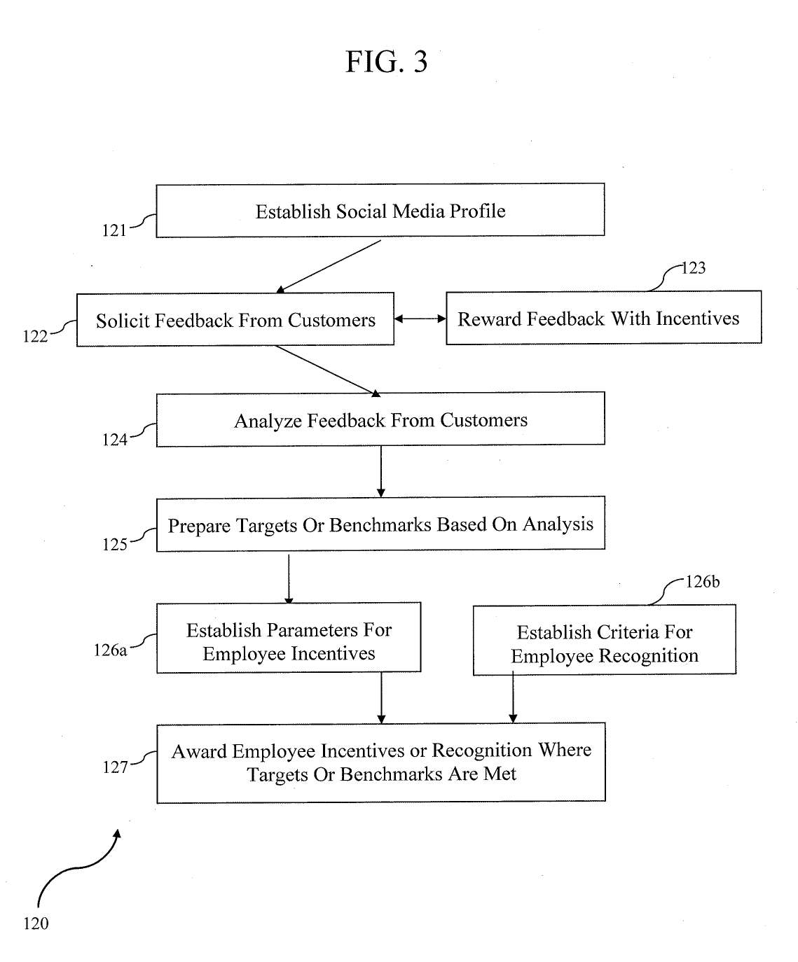

As depicted in FIG. 3, procedures for offering incentives and recognition to customers and/or to employees of the merchant are shown in a flowchart 120. At procedure 121, the merchant, or a corporate parent of the merchant, may establish a social media profile on a social media platform. As previously discussed, this procedure may be performed manually, by agents of the merchant, or it may be performed automatically, using a template of a software program configured to operatively communicate with the system of the social media platform. At procedure 122, the merchant may solicit feedback from customers regarding a particular topic of interest, which may be a product or service, or improvement to customer service, among other things. At procedure 123, the merchant may provide the customer with an incentive for responding to the feedback solicitation. This incentive may include, among other things, promotional offers, discounts on products or services, free products or services, points in the loyalty program, or other incentives. At procedure 124, the feedback information may be analyzed, either manually by an agent of the merchant or using the software program, which has been configured to retrieve and analyze information from the social media platform. At procedure 125, the merchant, or a corporate parent of the merchant, may prepare one or more targets or benchmarks, which, in some embodiments, may be based at least in part on the analysis of the customer feedback. Such targets or benchmarks may comprise a desired performance level for the particular topic of interest. Thereafter, at procedure 126a, the merchant, or a corporate parent of the merchant, may establish parameters for providing employees incentives and/or recognition for performance metrics based on customer feedback. As discussed above, incentives may include anything of value to the employee, and recognitions may be posted on a social media webpage of the employee using the presently disclosed social media platform. These parameters may take the form of store competitions, regional competitions, or individual employee or merchant goal-setting, in order to delineate what level of performance needs to occur for the employee, or group of employees, to be eligible for the incentive or recognition. In another embodiment, without regard to the feedback information discussed above, a merchant may alternatively or additionally be desirous of providing a recognition to an employee for any employment related conduct. In such embodiments, for example, at procedure 126b, the merchant may set the goals, parameters, or other metrics wherein if an employee performs according to such standards or metrics, the employee will be deserving of a recognition. At procedure 127, employees, or groups of employees, that meet or exceed the parameters set forth by the merchant location, or the corporate parent as set forth in procedure 126a, or any employee to whom the merchant is desirous of awarding a recognition for employment-related performance as set forth in procedure 126b, may be awarded the incentives or recognition (such as a posting on the employee's social media webpage). As with customer incentives, employee incentives may include discounts on products or services and free products or services from the merchant. Employee incentives may also include increased pay, promotions, bonuses, time off, and increased perquisites, or any other suitable incentive or combination of incentives. Employee recognition may include verbal, written, or electronic recognition, including electronic textual or visual recognition that is posted on a social media webpage of the employee, on a social media webpage of the merchant, or on a general website of the merchant. Of course, it will be appreciated that while FIG. 3 depicts certain procedures as enumerated above, more or fewer procedures may be employed, including eliminating iterative procedures, consistent with the scope of the present disclosure. Moreover, procedures shown in FIG. 3 need not necessarily be executed in the order presented.

In further embodiments of the present disclosure, the feedback response mechanism of the system and method may be used to track the performance of a particular marketing campaign. Traditionally, marketing campaigns have been judged by non-direct means, for example, an increase in customer traffic or customer purchases of a particular item over time, which may or may not be related to the marketing campaign of interest. In contrast, the presently described system and method may allow a merchant to directly track the effectiveness of a marketing campaign by targeting questions to customers who have a relationship with the merchant through the social media platform regarding the marketing campaign. For example, if a marketing campaign involves a discount on a particular product, a question may be posed to the customer asking if the particular discount incentivized the customer to go into the merchant location and purchase that product. Other questions can be similarly designed based on other marketing campaigns. In this manner, through the existing social connection the merchant has with the customer through the social media platform, the merchant can gauge the effectiveness of different types of marketing campaigns, and thereafter made repeated use of marketing campaigns that are the most effective, based on customer responses received through the social media platform.

The social media paradigm disclosed herein may provide further benefits to the merchant beyond the two-way customer communication examples, as described above. In one embodiment, the merchant, through their social media profile, may have access to personal or demographic information about customers who have established a social media relationship with the merchant through their own profile on the social media website. For example, it is common on many social media websites that a first user has access to any information that a second user, who has established a relationship with the first user, allows to be shared publicly. This information may include not only basic demographic information, such as age, sex, residency, etc., but also may include information regarding interests, activities, and social relationships that may be of interest to the merchant for marketing purposes. In one embodiment, an agent of the merchant may access the profile of a customer who has an established relationship therewith to survey the profile for relevant information. In another embodiment, the merchant may employ a software program configured to access and interact with the social media website in order to survey one or more customer profiles for personal useful data.

Embodiments of the present disclosure may be implemented through one or more computing devices connected with one another through an electronic network. As shown particularly in FIG. 4, a computing device used with the present disclosure, may be part of a larger network system 225 of devices. System 225 may include one or more computing devices 226 connected with a network 250, such as the Internet. Computing device 226 can interact with a server 246 in order to input and receive information, for example but not limited to, marketing or customer feedback information, as described above.

System 225 may also include the ability to access one or more web site servers 248 in order to obtain content from the Internet for use with the social media-based systems and methods described herein. While only one computing device is shown for illustrative purposes, system 225 may include a plurality of computing devices 226 and may be scalable to add or remove computing devices to or from a network.

Computing device 226 illustrates components of an embodiment of a suitable computing device for use with the present disclosure. Computing device 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250, for example, a network connecting the computing devices to the system of the social media platform. Input interface 203 may include any device for entering information into computing device 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access a social media platform, for example, by connecting the host server of the social media platform. Any commercial or freeware web browser or other application capable of retrieving content from a network and displaying pages or screens may be used. In some embodiments, a customized application 280 may be used to access, display, and update information.

A server 246, for example located at a merchant location, may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non-volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing customer feedback information, and other data. Any type of data structure can be used, such as a relational database or an object-oriented database.

Processors 242, 262 may, alone or in combination, execute one or more applications 280, 281 in order to provide some or all of the functions, or portions thereof, of the social media-based system and method described herein.

A particular benefit of the presently disclosed system and method is to drive loyalty to a particular merchant, networked merchants, or to a particular brand. By establishing an online community through a social media website, the merchant is able to more consistently and more directly interact with its customers, to provide the customers with information about the merchant, or the merchant's operations, and to gain valuable feedback information from the customer regarding the customers experience at the merchant. In this manner, by establishing a social relationship with the customer, the customer may feel more loyal to the merchant or to the particular brands, and may be more likely to provide repeat business to the merchant as opposed to patronizing a competing merchant where the customer does not have an established relationship.

Along with brand loyalty, a social media profile may allow a merchant to increase customer satisfaction by providing dynamic, substantially real-time, or otherwise quick responses to customer inquiries, complaints, or other feedback, so as to improve the overall customer experience. Where a customer feels like their needs are being well-met by a merchant, the customer may be more likely to repeatedly shop at the merchant for products and services, which may thus increase the sales at the merchant, and also likely profitability. Furthermore, by identifying areas of inefficiency by closely monitoring customer feedback, the merchants may be able to operate more efficiently, thus reducing overhead costs, and also likely increasing profitability.

Furthermore, using a social media platform to establish online customer relationships may also allow the merchant to create an online forum centered around the merchant, or the brand identity of the merchant, wherein users are incentivized to post self-made content thereon in order to further develop a community identity centered around the merchant. As is well known, media websites such as YouTube™ that allow users to post self-made content develop discussion forums around particular subjects where users post their own self-made content about that particular subject. In the context of a merchant, using a social media platform, users can post self-made content about experiences that they have had had that merchant location, which therefore encourages other users to participate in the conversation and become part of the community centered around the merchant. This community may help to drive brand loyalty, where customers are drawn to a particular merchant location by the established relationship that they have with it, as opposed to going to a different merchant location where they may not have such an active social relationship or established social community.

A further advantage of the systems and methods of the present disclosure relate to the incentives and recognition that may be provided to employees for meeting or exceeding benchmarking targets. Employees may also be provided recognition for any other employment related reason, such as meeting a particular goals, achieving a particular milestone, or performing their duties in a distinguished manner. Using social media as an intermediary, the merchant may be more efficiently and more accurately able to reward and recognize employees who meet expectations, and identify other employees for further training. As opposed to known systems where employee rewards are based on supervisor evaluations, which may be based on limited supervisor observations of the employee's performance, the presently disclosed system may allow merchants to gather a much better perspective of individual or overall employee performance at a merchant locations, or within a region of merchants, to better reward and incentivize recognize employees. With particular regard to employee recognition posted on such employee's social media webpage using the social media platform, it will be appreciated that the social media platform provides an integrated system where a merchant can manage customer feedback, and also recognize employees when targets have been achieved or employees that have otherwise performed well in one way or another. Employees may be highly receptive to such recognition (and therefore strive diligently to achieve the set goals) because such recognition may help the employee with career advancement, business networking, and overall esteem within the professional community to which the employee belongs (which may include a social media virtual community).

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. Furthermore, whereas the term “incentive” as used herein makes general reference to one or more enumerated incentives, it will be appreciated that such incentive may be provided in combination, e.g., providing two or more such incentives. These and other variations, modifications, additions, and improvements may fall within the scope of the disclosure as defined in the claims that follow.

What is claimed is:

1. An electronically implemented method for providing an employee recognition using social media, comprising:
providing a computing system comprising a processor and a data storage component, wherein the data storage component comprises instructions to cause the processor to:
receive, through a social media platform, an electronic request from a merchant location to provide an electronic recognition to the employee based on the employee's employment-related performance; and
provide the recognition to the employee by accessing an electronic forum and posting the recognition in electronic format on such electronic forum.

2. The method of claim 1, wherein providing the recognition comprises posting the recognition on a social media webpage of the employee.

3. The method of claim 2, wherein providing the recognition to the employee by accessing an electronic forum comprises using the social media platform to access the social media webpage of the employee.

4. The method of claim 3, wherein access to the social media webpage of the employee is accomplished using one or more of a password, merchant verification, or preexisting electronic relationship between the merchant and the employee.

5. The method of claim 1, wherein the recognition is a textual recognition, the language of which being provided by the merchant.

6. The method of claim 1, wherein the employee has a previously established social media relationship with the merchant location through the social media platform.

7. A computer readable storage medium comprising computer-accessible instructions stored thereon which, when read by a computer, will cause the computer to:
receive, through a social media platform, an electronic request from a merchant location to provide an electronic recognition to the employee based on the employee's employment-related performance; and
provide the recognition to the employee by accessing an electronic forum and posting the recognition in electronic format on such electronic forum.

8. An electronically implemented method for providing an employee recognition using social media, comprising:
providing a computing system comprising a processor and a data storage component, wherein the data storage component comprises instructions to cause the processor to:
transmit, through a social media platform, an electronic feedback response request to a consumer relating to a topic of interest at a merchant location; and
receive, through the social media platform, a consumer feedback response responsive to the response request;
comparing the feedback response to target response parameters; and
providing a recognition to one or more employees at the merchant location if the consumer feedback response is within the target response parameters.

9. The method of claim 8, wherein the target response parameters are based on regional performance goals applicable to a plurality of merchant locations within a selected region.

10. The method of claim 8, wherein the topic of interest is selected from one or more of a product sold at the merchant location, a service provided at the merchant location, or a customer experience at the merchant location.

11. The method of claim 8, comprising providing an employee incentive, and wherein the employee incentive includes one or more of a monetary reward or a discount on a product or service sold at the merchant location.

12. The method of claim 8, comprising providing an incentive to the consumer for responding to the consumer response component.

13. The method of claim 8, wherein the received feedback response is electronically uploaded to a merchant database of the data storage component.

14. The method of claim 8, wherein the topic of interest is related to employee performance at a merchant location.

15. The method of claim 14, wherein the target response parameters are based on a desired employee performance.

16. The method of claim 15, wherein an employee at the merchant location is provided a recognition where the consumer feedback substantially falls within the target response parameters.

17. The method of claim 8, wherein providing the recognition comprises posting the recognition on a social media webpage of the employee.

18. The method of claim 17, wherein providing the recognition comprises using the social media platform to access the social media webpage of the employee.

19. The method of claim 18, wherein access to the social media webpage of the employee is accomplished using one or more of a password, merchant verification, or preexisting electronic relationship between the merchant and the employee.

20. The method of claim 1, wherein the recognition is a textual recognition, the language of which being provided by the merchant.
